(19) United States
(12) Patent Application Publication
(10) Pub. No.: US 2002/0137387 A1
(43) Pub. Date: Sep. 26, 2002

(54) Adjustable plug

(76) Inventor: Tien-Hui Lin, Taipei (TW)

Correspondence Address: DOUGHERTY & TROXELL, 5205 LEESBURG PIKE SOUTH SUITE 1404, FALLS CHURCH, VA, 22041, US

(21) Appl. No.: 09/735,497

(22) Filed: Dec. 14, 2000

(51) Int. Cl. H01R 13/56

(52) U.S. Cl. 439/446

(57) ABSTRACT

The present invention discloses an adjustable plug comprising a pair of corresponding casings forming a concave groove at an end with a plugging member, said plugging member further comprising two electric ends and a ground end. An axial rod passes through said plugging member and one of the two electric ends inside said plugging member deposed at an axial hole each on both sides and a screw hole deposed on said plugging member for facilitating the screwing or disassembling an end having a grounding end with the thread of a screw. Such arrangement makes the adjustable plug of the present invention adjustable up and down in a vertical position and arbitrarily switched between a two-hole socket and a three-hole socket. Such adjustable plug can adopt sockets in different angles or with different number of holes for convenience and practicability.

### BACKGROUND OF THE INVENTION

1. Field of the Invention

The present invention relates to an adjustable plug, more particularly to a plug adjustable up and down in a vertical position and arbitrarily switched between a two-hole socket and a three-hole socket. Such adjustable plug can adopt sockets in different angles or with different number of holes for convenience and practicability.

2. Description of the Prior Art

As in the era when technologies advance day after day, people are paying more attention to their daily necessities; electric appliances are essential to every family, and plugs are needed for supplying power to each of the electric appliances. Therefore electric appliance manufacturers are conducting research and development for an adjustable plug that can accommodate a two-hole socket or a three-hole socket at different angles from the different positions vertically up and down.

Conventional electric plugs are divided into two-hole plugs and three-hole plugs; such two-hole plug has two electric terminals and three-hole plug has two electric terminals and a grounding terminal. Most of the electric appliances in countries like Taiwan use two-hole plugs, and therefore most of the electric sockets are two-holed, such as television, radio, refrigerator, etc., and the electric appliances using three-hole sockets include computers and peripherals such as printer, scanner, monitor, etc. These electric appliances need three-hole sockets and that will increase the material cost for electric appliance manufacturers, or the three-hole plugs need a rework by cutting the ground terminal before use. This causes inconvenience to users. Furthermore, most of the plugs are fixed and the position of the sockets in Taiwan are designed to depose vertically or horizontal at the corner of the wall. This design makes the connection very difficult; in addition, the distance between sockets are too close, when a socket is plugged with several electric plugs, it is not easy to plug additional ones to the socket. Users have to unplug some of the plugs before additional one can be installed or rearrange the cable of the plugs to avoid tangling the cables. This results an inconvenience to users and reduces the practical performance.

In view of the above-mentioned shortcomings of the conventional plug, the inventor of the present invention based on years of experience accumulated from the engagement in the related industry conducted extensive research to resolve the foregoing shortcomings and invented the present electric plug which makes use of an axial rod passing through a plugging member and one of the two electric ends inside the plugging member deposed at an axial hole each on both sides and a screw hole deposed on said plugging member for facilitating the screwing or disassembling an end having a grounding end with the thread of a screw.

Therefore, the primary objective of the invention is to design an adjustable plug that can fit in sockets in different positions and can be adjusted up and down vertically, and can accommodate sockets of different number of holes including the two-hole socket and the three-hole socket.

To make it easier for our examiner to understand the objective of the invention, its structure, innovative features, and its performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows a three-dimensional diagram of the present invention.

FIG. 2 shows a three-dimensional diagram of the disassembled parts of the present invention.

FIG. 3 shows a lateral cross-section of the present invention.

FIG. 4 shows the disassembled diagram of the grounding end of the present invention.

FIG. 5 shows the adjusting motion according to the present invention.

FIG. 6 shows another embodiment of the present invention.

FIG. 7 shows the adjusting motion according to FIG. 6.

### DESCRIPTION OF THE PREFERRED EMBODIMENT

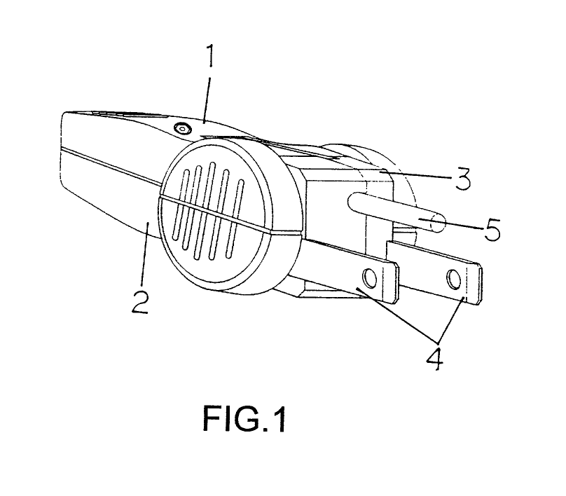

Please refer to FIG. 1 for the three-dimensional diagram of a preferred embodiment of the present invention. As shown in the figure, an adjustable plug according to the present invention comprises a pair of corresponsive casings namely an upper casing 1 and a lower casing 2. A plugging member 3 is adjustable up and down vertically being pivoted at one of the end of the casings, and such plugging member 3 has 2 electric terminals 4 and a ground terminal 5.

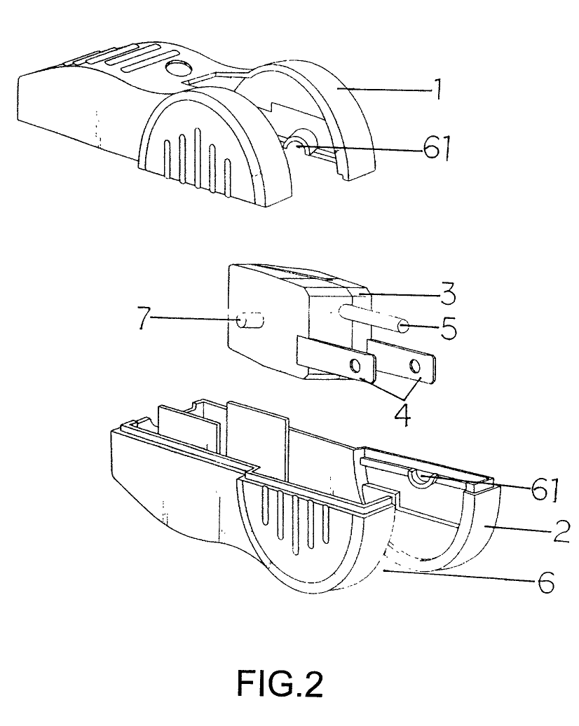

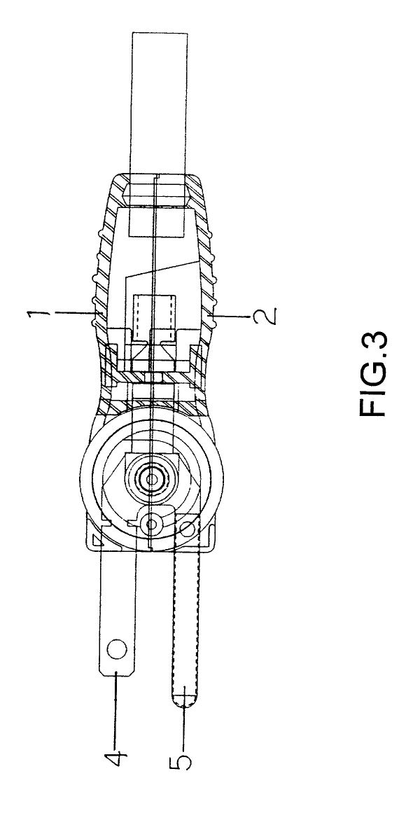

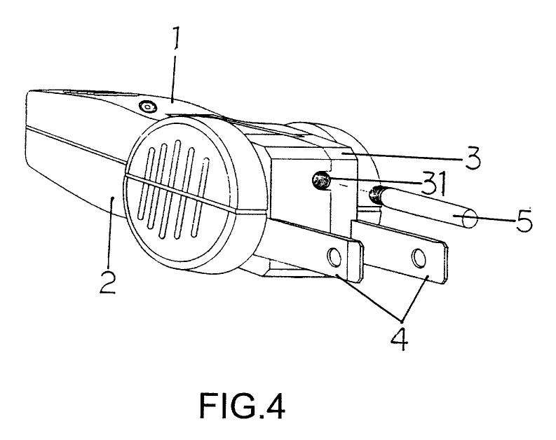

Further refer to FIG. 2 for the three-dimensional diagram of the disassembled parts of the present invention. The adjustable plug of the present invention is composed of a pair of corresponsive casing (an upper casing 1 and a lower casing 2). It forms a concave groove 6 at one of the ends of the casing; said concave groove has an axial hole 61 at each of the lateral sides of it. An axial rod 7 passes through a plugging member 3 and the two electric terminals 4 inside said plugging member 3 and is pivoted at the lateral holes 61 on said concave groove 6. A screw hole 31 is deposed at the appropriate location on said plugging member 3 for conveniently screwing or unscrewing the ground terminal 5. When the socket is a three-hole socket, screw the ground terminal 5 into the screw hole 31 of the plugging member 3, and then plug the plugging member into the three-hole socket. When the socket is a two-hole socket, unscrew the ground terminal 5 from the screw hole 31 of the plugging member 3. As shown in FIG. 4, plug the plugging member 3 into the two-hole socket. By the foregoing special arrangement, the plug of the present invention can accommodate a two-hole socket as well as a three-hole socket and can adopt sockets of different number of holes.

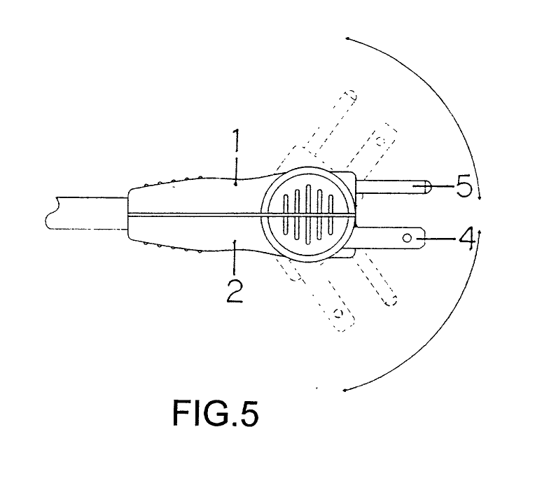

Please refer to FIG. 5, an embodiment of the present invention makes use of an axial rod 7 passing through one end of the two electric terminals 4 of a plugging member 3 pivoted at an axial hole 61 deposed at both lateral sides of a concave groove 6 composed of a pair of corresponsive casings (an upper casing 1 and a lower casing 2). Such arrangement can adjust the position of the plugging member 3 up and down vertically according to the different positions of the socket. When the plugging member 3 of this invention is plugged into the socket and the plugs of other electric appliances are being plugged into the socket, the users need not to unplug the plugging members. All he needs to do is to make an up and down adjustment vertically along the axial rod 7 of the upper casing 1 and the lower casing 2. It can prevent the tangling of the cables of other electric appliances.

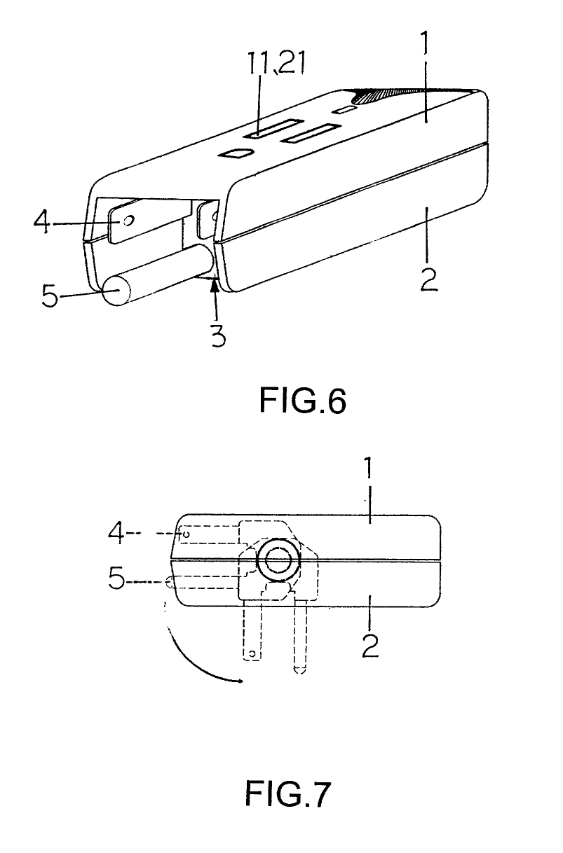

Please refer to FIG. 6 for another embodiment of the present invention. Three-holes can be deposed on the external surface of the upper and lower casings 1, 2 or on the surface of one of the casings forming an adapting socket for receiving either a two-hole plug or a three-hole plug. When vertical downward adjustment is being performed, press the plugging member along the direction as indicated in the figure.

In view of the descriptions above, the adjustable plug of the present invention is innovative and more advantageous than the conventional electric plug having the foregoing advantages and complies with the patent application requirements. Hence the present invention is submitted to the Patent and Trademark Office for review and the granting of the commensurate patent.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An adjustable plug comprising a pair of corresponding casings forming a concave groove at an end with a plugging member, said plugging member further comprising two electric ends and a ground end; an axial rod passing through said plugging member and one of the two electric ends inside said plugging member deposed at an axial hole each on both sides and a screw hole deposed on said plugging member for facilitating the screwing or disassembling an end having a grounding end with the thread of a screw.

2. An adjustable plug according to claim 1, wherein a hole is deposed on the surface of said two casings or a casing for forming a divergent plug.
